(19) United States
(12) Patent Application Publication
(10) Pub. No.: US 2017/0169211 A1
(43) Pub. Date: Jun. 15, 2017

(54) ONE KIND OF WEBSITE PASSWORDS GENERATING METHOD AND APPARATUS

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Yang GAO, Beijing (CN)

(73) Assignees: LE HOLDINGS (BEIJING) CO., LTD., Beijing (CN); LE SHI INTERNET INFORMATION & TECHNOLOGY CORP., BE IJING, Beijing (CN)

(21) Appl. No.: 15/243,270

(22) Filed: Aug. 22, 2016

Related U.S. Application Data
(63) Continuation of application No. PCT/CN2016/089559, filed on Jul. 10, 2016.

(30) Foreign Application Priority Data
Dec. 15, 2015 (CN) 201510930013.3

(51) Int. Cl. G06F 21/46; H04L 29/06

(52) U.S. Cl. CPC G06F 21/46; H04L 63/06; H04L 63/083

(57) ABSTRACT

A method and electronic device for generating a website password are provided. The method for generating a website password includes: receiving a key, a domain name of a website, and a username on the website entered by a user, receiving a password setting rule of the website from the user or acquiring a password setting rule of the website; and performing computation on the following items to automatically generate a unique and constant website password for the user: the key, the domain name of the website, the username on the website, and the password setting rule of the website. With the method and electronic device for generating a website password, a unique and constant website password may be automatically generated for the user.

### CROSS REFERENCE TO RELATED APPLICATIONS

This application is a continuation of PCT application No. PCT/CN2016/089559 submitted on Jul. 10, 2016, which is based upon and claims priority to Chinese Patent Application No. 201510930013.3, filed before Chinese Patent Office on Dec. 15, 2015 and entitled “METHOD AND DEVICE FOR GENERATING WEBSITE PASSWORD”, the entire contents of which are incorporated herein by reference.

### TECHNICAL FIELD

The present disclosure relates to the field of Internet, and more particularly, to a method and electronic device for generating a website password.

### BACKGROUND

At present, when a user registers on a website, the user sets a password according to a password setting rule of the website. However, the passwords may be easily cracked if they are too simple, or may be forgotten by the user if they are too complicated.

### SUMMARY

On a first aspect, an embodiment of the present disclosure provide a method for generating a website password. The method for generating a website password includes: receiving a key, a domain name of a website, and a username on the website entered by a user, and receiving a password setting rule of the website from the user or acquiring a password setting rule of the website from the website; and performing computation on the following items to automatically generate a unique and constant website password for the user: the key, the domain name of the website, the username on the website, and the password setting rule of the website.

On a second aspect, an embodiment of the disclosure further provides a non-transitory computer-readable storage medium which stores computer executable instructions that when executed by an electronic device, cause the electronic device to perform any of the foregoing methods for generating a website password of the disclosure.

On a third aspect, an embodiment of the disclosure further provides an electronic device, including: at least one processor; and a memory, where the memory stores instructions that can be executed by the at least one processor, and wherein execution of the instruction by the at least one processor causes the at least one processor to perform any of the foregoing methods for generating a website password of the disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

The accompanying drawings are used to provide further understanding of the present disclosure, to form a part of the specification. The accompanying drawings are used to explain the present disclosure together with the following specific implementation manners, but do not form a limitation to the present disclosure. In the accompanying drawings:

FIG. 1 is a flowchart of a method for generating a website password according to an embodiment of the present disclosure;

FIG. 2 is a block diagram illustrating an apparatus for generating a website password according to an embodiment of the present disclosure; and

FIG. 3 is a block diagram of an apparatus for generating a website password according to another embodiment of the present disclosure; and

FIG. 4 is a schematic structural diagram of hardware of an electronic device for executing a method for generating a website password according to another embodiment of the present disclosure.

### DETAILED DESCRIPTION

Specific embodiments of the present disclosure are described hereinafter in detail with reference to the accompanying drawings. It should be understood that the specific embodiments described hereinafter are merely used for describing and explaining the present disclosure, and are not intended to limit the present disclosure.

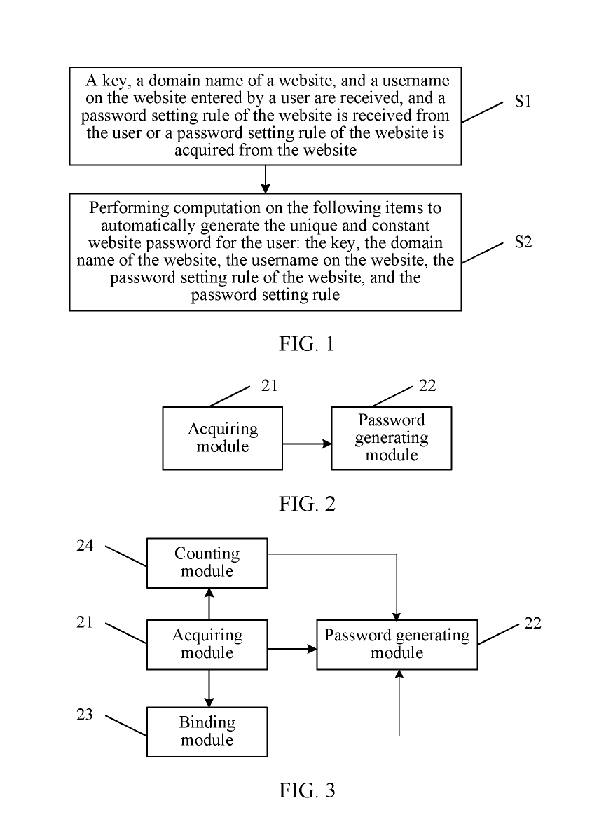

An embodiment of the present disclosure provides a method for generating a website password. As illustrated in FIG. 1, the method for generating a website password may include the following steps:

In step S1: A key, a domain name of a web site, and a username on the web site entered by a user are received, and a password setting rule of the web site is received from the user or a password setting rule of the website is acquired from the website; and

In step S2: Computation is performed on the following items to automatically generate a unique and constant website password for the user: the key, the domain name of the website, the username on the website, and the password setting rule of the website.

Optionally, the key may be characters that may be easily memorized by the user. The key is set by the user per se, for example, the user may set the key as a simple combination of digits, a simple combination of letters, a simple combination of digits and letters, or a simple combination of digits, letters, and common symbols, as long as the key is easy to memorize. In addition, in the method for generating a website password according to the present disclosure, the unique and constant website password for the user is automatically generated by performing computation on the key, the domain name of the website, the username on the website, and the password setting rule of the website. Because a website password that is unique, constant, and difficult to crack is generated for the user by using the method for generating a website password according to the present disclosure, the user does not have the problem that the key is too simple.

In addition, the password setting rule of the website may include a range of password length and a password composition rule, where the password composition rule, for example, may be that the website password needs to include one of or a combination of Arabic numerals, English letters, and common symbols. The password setting rule of each website is prescribed by the website per se, and therefore, the password setting rule of the website herein is associated with the website which the user intends to visit. Optionally, the domain name of the website may include an abbreviation and a common name of the domain name on the web site that are bound to each other. Using the domain name of the website www.tudou.com as an example, the method for generating a website password according to the present disclosure will first bind the abbreviation “tudou” and the common name “potato” of the domain name of the website “www.tudou.com”. After that, no matter “tudou” or “potato” is entered by the user, the method for generating a website password according to the present disclosure can automatically generate the same unique and constant website password for the user, for example, generate “aaaa” as the website password.

Optionally, before or after step S1, the method for generating a website password according to the present disclosure may further include: binding the username on the website, a mobile phone number of the user, and an email address of the user, and binding all web site domain names in a domain name group; and performing, in step S2, computations on the following items to automatically generate the same unique and constant website password for the user: (1) the key; (2) the domain name of the website; (3) any one of the username on the website, the mobile phone number of the user, and the email address of the user; and (4) the password setting rule of the web site.

For example, if domain names of multiple websites are associated with each other, the domain names of the websites can be classified into one domain name group and be bound. Using domain names www.taobao.com and www.tmall.com as an example, the domain names of the two websites are classified into one domain name group because they are associated with each other; moreover, the abbreviations and common names of the domain names of the two websites are bound to each other, for example, tmall, tianmao, taobao, and TAOBAO are all bound. As a result, when the user generates a website password by using the method for generating a website password according to the present disclosure, no matter the domain name of the website entered by the user is tmall, tianmao, taobao, or TAOBAO, the method for generating a website password according to the present disclosure can automatically generate the same unique and constant website password for the user.

Similarly, in the case in which the username on the website, the mobile phone number of the user, and the email address of the user are bound to each other, when the user generates a website password by using the method for generating a website password according to the present disclosure, no matter the username on the website, the mobile phone number of the user, or the email address of the user is entered by the user, the method for generating a website password according to the present disclosure can automatically generate the same unique and constant website password for the user.

Optionally, the method for generating a website password according to the present disclosure may further include: receiving a user-defined password setting rule entered by the user, where the user-defined password setting rule satisfies requirements of the password setting rule of the website; and performing computation on the following items to automatically generate the unique and constant website password for the user: the key, the domain name of the web site, the username on the web site, the password setting rule of the website, and the user-defined password setting rule. The user-defined password setting rule may include user-defined characters for making up the password, for example, the user may specify, in the user-defined password setting rule, that the Arabic numerals in the website password generated by using the method for generating a website password according to the present disclosure include only 1, 2, and 3, and that the common symbols include only “_”, and the like. The user may also specify, in the user-defined password setting rule, the length of the web site password generated by using the method for generating a web site password according to the present disclosure.

Optionally, the method according to the present disclosure may further include: in step S1, a password resetting command entered by the user is received; after step S1, times for the user to reset the password is counted. When automatically generating a unique and constant website password for the user in step S2, the computation items further include the password resetting times. Therefore, the method according to the present disclosure also allows the user to reset the website password. For example, supposing that the website password previously generated by the user by using the method for generating a website password according to the present disclosure is aaaa, and the password has been reset twice by the user, when the user enters the password resetting command again, the method according to the present disclosure will perform computation on the key, the domain name of the website, the username on the website, the password setting rule of the website, the password resetting times (that is, 3), and a possible user-defined password setting rule so as to automatically generate a new unique and constant website password for the user, for example, bbbb.

In addition, in step S2, the computation performed on the key, the domain name of the website, the username on the website, the password setting rule of the website, and the possible password resetting times and user-defined password setting rule may be the Hash computation, md5, and pseudo-random computation.

An embodiment of the present disclosure further provides an apparatus for generating a website password. As illustrated in FIG. 2, the apparatus for generating a website password includes: an acquiring module 21, and a password generating module 22. The acquiring module 21 receives a key, a domain name of a website, and a username on the web site entered by a user, and receives a password setting rule of the web site from the user or acquires a password setting rule of the website from the website; and the password generating module 22 performs computation on the following items to automatically generate a unique and constant website password for the user: the key, the domain name of the website, the username on the website, and the password setting rule of the website.

Optionally, the key may be characters that can easily memorized by the user. The key is set by the user per se, for example, the user can set the key as a simple combination of digits, a simple combination of letters, a simple combination of digits and letters, or a simple combination of digits, letters, and common symbols, as long as the key is easy to memorize. In addition, the apparatus for generating a website password according to the present disclosure automatically generates the unique and constant website password for the user by performing computation on the key, the domain name of the web site, the username on the website, and the password setting rule of the website. Because the apparatus for generating a website password according to the present disclosure generates a website password that is unique, constant, and difficult to crack for the user, the user does not have the problem that the key is too simple.

In addition, the password setting rule of the website may include a range of password length and a password composition rule, where the password composition rule, for example, may be that the website password needs to include one of or a combination of Arabic numerals, English letters, and common symbols. The password setting rule of each website is prescribed by the website per se, and therefore, the password setting rule of the website herein is associated with the website to which the user intends to visit.

Optionally, the domain name of the website may include an abbreviation and a common name of the domain name on the website that are bound to each other. Using the domain name of the web site www.tudou.com as an example, the apparatus for generating a website password according to the present disclosure will first bind the abbreviation “tudou” and the common name “potato” of the domain name of the website “www.tudou.com”. After that, no matter “tudou” or “potato” is entered by the user, the apparatus for generating a website password according to the present disclosure can automatically generate the same unique and constant website password for the user, for example, generate “aaaa” as the website password.

Optionally, as shown in FIG. 3, the apparatus for generating a website password according to the present disclosure may further include a binding module 23, the binding module 23 bind the username on the website, a mobile phone number of the user, and an email address of the user, and bind all website domain names in a domain name group; and the password generating module 22 further performs computations on the following items to automatically generate the same unique and constant website password for the user: (1) the key; (2) the domain name of the website; (3) any one of the username on the website, the mobile phone number of the user, and the email address of the user; and (4) the password setting rule of the website.

For example, if domain names of multiple websites are associated with each other, the domain names of the websites can be classified into one domain name group and be bound. Using domain names www.taobao.com and www.tmall.com as an example, the domain names of the two websites are classified into one domain name group because they are associated with each other; moreover, the abbreviations and common names of the domain names of the two websites are bound to each other, for example, tmall, tianmao, taobao, and TAOBAO are all bound. As a result, when the user generates a website password by using the apparatus for generating a website password according to the present disclosure, no matter the domain name of the website entered by the user is tmall, tianmao, taobao, or TAOBAO, the apparatus for generating a web site password according to the present disclosure can automatically generate the same unique and constant website password for the user.

Similarly, in the case in which the username on the website, the mobile phone number of the user, and the email address of the user are bound to each other, when the user generates a website password by using the apparatus for generating a website password according to the present disclosure, no matter the username on the web site, the mobile phone number of the user, or the email address of the user is entered by the user, the apparatus for generating a website password according to the present disclosure can automatically generate the same unique and constant website password for the user.

Optionally, the acquiring module 21 may further receive a user-defined password setting rule entered by the user, where the user-defined password setting rule satisfies requirements of the password setting rule of the website; and the password generating module 22 performs computation on the following items to automatically generate the unique and constant website password for the user: the key, the domain name of the website, the username on the website, the password setting rule of the website, and the user-defined password setting rule. The user-defined password setting rule may include user-defined characters for making up the password, for example, the user may specify, in the user-defined password setting rule, that the Arabic numerals in the website password generated by using the apparatus for generating a website password according to the present disclosure include only 1, 2, and 3, and that the common symbols include only “_”, and the like. The user may also specify, in the user-defined password setting rule, the length of the website password generated by using the apparatus for generating a web site password according to the present disclosure.

Optionally, as shown in FIG. 3, the apparatus for generating a website password according to the present disclosure may further include a counting module 24, where: the acquiring module 21 further receives a password resetting command entered by the user; the counting module 24 counts times for the user to reset the password. When automatically generating a unique and constant website password for the user, the computation items by the password generating module 22 further include the password resetting times. Therefore, the apparatus according to the present disclosure also allows the user to reset the website password. For example, supposing that the website password previously generated by the user by using the apparatus for generating a web site password according to the present disclosure is aaaa, and the password has been reset twice by the user, when the user enters the password resetting command again, the password generating module 22 will perform computation on the key, the domain name of the website, the username on the website, the password setting rule of the website, the password resetting times (that is, 3), and a possible user-defined password setting rule so as to automatically generate a new unique and constant web site password for the user, for example, bbbb.

In addition, the password generating module 22 may perform computation on the key, the domain name of the web site, the username on the web site, the password setting rule of the website, and the possible password resetting times and user-defined password setting rule by means of the Hash computation, md5, and pseudo-random computation.

Another embodiment of the disclosure provides a non-transitory computer storage medium, which stores a computer executable instruction, where the computer executable instruction can execute the processing method of a list item computation of any of the foregoing method embodiments of the disclosure.

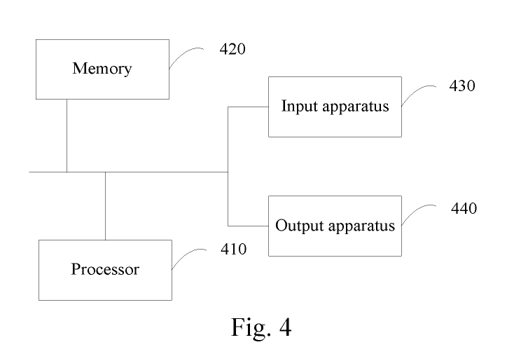

FIG. 4 is a schematic structural diagram of hardware of an electronic device for executing a method for generating a website password provided by another embodiment of the disclosure. As shown in FIG. 4, the device includes: one or more processors 410 and a memory 420, with one processor 410 as an example in FIG. 4.

A device for executing the method for generating a website password may further include: an input apparatus 430 and an output apparatus 440.

The processor 410, the memory 420, the input apparatus 430, and the output apparatus 440 can be connected by means of a bus or in other manners, with a connection by means of a bus as an example in FIG. 4.

As a non-transitory computer readable storage medium, the memory 420 can be used to store non-transitory software programs, non-transitory computer executable programs and modules, for example, a program instruction/module corresponding to the method for generating a website password in the embodiments of the disclosure (for example, an acquiring module 21 and a password generating module 22 shown in FIG. 2). The processor 410 executes various functional disclosures and data processing of the server, that is, implements the method for generating a website password of the foregoing method embodiments, by running the non-transitory software programs, instructions, and modules stored in the memory 420.

The memory 420 may include a program storage area and a data storage area, where the program storage area may store an operating system and at least one disclosure needed by function; the data storage area may store data created according to use of an apparatus for generating a website password, and the like. In addition, the memory 420 may include a high-speed random access memory, and also may include a non-transitory memory, such as at least one disk storage device, flash storage device, or other non-transitory solid-state storage devices. In some embodiments, the memory 420 optionally includes memories remotely disposed with respect to the processor 410, and the remote memories may be connected, via a network, to the apparatus for generating a website password. Examples of the foregoing network include but are not limited to: the Internet, an intranet, a local area network, a mobile communications network, and a combination thereof.

The input apparatus 430 can receive entered digit or character information, and generate key signal inputs relevant to user setting and functional control of the processing apparatus of a list item computation. The output apparatus 440 may include a display device, for example, a display screen, etc.

The one or more modules are stored in the memory 420, and execute the method for generating a web site password in any one of the foregoing method embodiments when being executed by the one or more processors 410.

The foregoing product can execute the method provided in the embodiments of the disclosure, and has corresponding functional modules for executing the method and beneficial effects. The method provided in the embodiments of the disclosure can be referred to for technical details that are not described in detail in the embodiment.

The electronic device in the embodiment of the disclosure exists in multiple forms, including but not limited to:

(1) Mobile communication device: such devices being characterized by having a mobile communication function and a primary objective of providing voice and data communications; such type of terminals including a smart phone (for example, an iPhone), a multimedia mobile phone, a feature phone, a low-end mobile phone, and the like;

(2) Ultra mobile personal computer device: such devices belonging to a category of personal computers, having computing and processing functions, and also generally a feature of mobile Internet access; such type of terminals including PDA, MID and UMPC devices, and the like, for example, an iPad;

(3) Portable entertainment device: such devices being capable of display and play multimedia content; such type of devices including an audio and video player (for example, an iPod), a handheld game console, an e-book, an intelligent toy and a portable vehicle-mounted navigation device;

(4) Server: a device that provides a computing service; the components of the server including a processor, a hard disk, a memory, a system bus, and the like; an framework of the server being similar to that of a general-purpose computer, but higher demanding in aspects of processing capability, stability, reliability, security, extensibility, manageability or the like due to a need to provide highly reliable services; and

(5) Other electronic apparatuses having a data interaction function.

The apparatus embodiments described above are merely schematic, and the units described as separated components may or may not be physically separated; components presented as units may or may not be physical units, that is, the components may be located in one place, or may be also distributed on multiple network units. Some or all modules therein may be selected according to an actual requirement to achieve the objective of the solution of the embodiment.

Through descriptions of the foregoing implementation manners, a person skilled in the art can clearly recognize that each implementation manner can be implemented by means of software in combination with a general-purpose hardware platform, and certainly can be also implemented by hardware. Based on such an understanding, the essence or a part contributing to the relevant technologies of the foregoing technical solutions can be embodied in the form of a software product. The computer software product may be stored in a computer readable storage medium, for example, a ROM/RAM, a magnetic disk, a compact disc or the like, including several instructions for enabling a computer device (which may be a personal computer, a sever, or a network device, and the like) to execute the method described in the embodiments or in some parts of the embodiments.

Finally, it should be noted that the foregoing embodiments are only for the purpose of describing the technical solutions of the disclosure, rather than limiting thereon. Although the disclosure has been described in detail with reference to the foregoing embodiments, a person of ordinary skill in the art should understand that he/she can still modify technical solutions disclosed in the foregoing embodiments, or make equivalent replacements to some technical features therein, while such modifications or replacements do not make the essence of corresponding technical solutions depart from the spirit and scope of the technical solutions of the embodiments of the disclosure.

What is claimed is:

1. A method for generating a website password, applied in an electronic device, comprising:
receiving a key, a domain name of a web site, and a username on the web site entered by a user, receiving a password setting rule of the web site from the user or acquiring a password setting rule of the website from a website; and
performing computation on the following items to automatically generate a unique and constant website password for the user: the key, the domain name of the website, the username on the website, and the password setting rule of the website.

2. The method according to claim 1, further comprising:
receiving a user-defined password setting rule entered by the user, wherein the user-defined password setting rule satisfies requirements of the password setting rule of the web site; and
performing computation on the following items to automatically generate the unique and constant website password for the user: the key, the domain name of the website, the username on the website, the password setting rule of the website, and the user-defined password setting rule.

3. The method according to claim 1, further comprising:
binding the username on the website, a mobile phone number of the user, and an email address of the user, and binding all website domain names in a domain name group; and
performing computation on the following items to automatically generate the unique and constant web site password for the user: (1) the key; (2) the domain name of the web site; (3) any one of the username on the web site, the mobile phone number of the user, and the email address of the user; and (4) the password setting rule of the website.

4. The method according to claim 1, wherein the domain name of the website comprises an abbreviation and a common name of the domain name on the website that are bound to each other.

5. The method according to claim 1, further comprising:
receiving a password resetting command entered by the user;
counting times for the user to reset the password; and
when the unique and constant website password are automatically generated for the user, the computation items further comprises the password resetting times.

6. A non-transitory computer-readable storage medium which stores computer executable instructions that, when executed by an electronic device, cause the electronic device to:
receive a key, a domain name of a web site, and a username on the web site entered by a user, receive a password setting rule of the website from the user or acquire a password setting rule of the website from a website; and
perform computation on the following items to automatically generate a unique and constant website password for the user: the key, the domain name of the website, the username on the website, and the password setting rule of the website.

7. The non-transitory computer-readable storage medium according to claim 1, wherein the electronic device is further caused to:
receive a user-defined password setting rule entered by the user, wherein the user-defined password setting rule satisfies requirements of the password setting rule of the web site; and
perform computation on the following items to automatically generate the unique and constant website password for the user: the key, the domain name of the website, the username on the website, the password setting rule of the website, and the user-defined password setting rule.

8. The non-transitory computer-readable storage medium according to claim 1, wherein the electronic device is further caused to:
bind the username on the website, a mobile phone number of the user, and an email address of the user, and bind all website domain names in a domain name group; and
perform computation on the following items to automatically generate the unique and constant website password for the user: (1) the key; (2) the domain name of the website; (3) any one of the username on the website, the mobile phone number of the user, and the email address of the user; and (4) the password setting rule of the website.

9. The non-transitory computer-readable storage medium according to claim 1, wherein the domain name of the website comprises an abbreviation and a common name of the domain name on the website that are bound to each other.

10. The non-transitory computer-readable storage medium according to claim 1, wherein the electronic device is further caused to:
receive a password resetting command entered by the user;
count times for the user to reset the password; and
when the unique and constant website password are automatically generated for the user, the computation items further comprises the password resetting times.

11. An electronic device, comprising:
at least one processor; and
a memory in communication connection with the at least one processor, wherein the memory stores instructions that can be executed by the at least one processor, and wherein execution of the instructions by the at least one processor causes the at least one processor to:
receive a key, a domain name of a web site, and a username on the web site entered by a user, receive a password setting rule of the website from the user or acquire a password setting rule of the website from a website; and
perform computation on the following items to automatically generate a unique and constant website password for the user: the key, the domain name of the website, the username on the website, and the password setting rule of the website.

12. The electronic device according to claim 11, wherein the at least one processor is further caused to:
receive a user-defined password setting rule entered by the user, wherein the user-defined password setting rule satisfies requirements of the password setting rule of the web site; and
perform computation on the following items to automatically generate the unique and constant website password for the user: the key, the domain name of the website, the username on the website, the password setting rule of the website, and the user-defined password setting rule.

13. The electronic device according to claim 11, wherein the at least one processor is further caused to:
bind the username on the website, a mobile phone number of the user, and an email address of the user, and bind all website domain names in a domain name group; and
perform computation on the following items to automatically generate the unique and constant website password for the user: (1) the key; (2) the domain name of the website; (3) any one of the username on the website, the mobile phone number of the user, and the email address of the user; and (4) the password setting rule of the website.

14. The electronic device according to claim 11, wherein the domain name of the website comprises an abbreviation and a common name of the domain name on the website that are bound to each other.

15. The electronic device according to claim 11, wherein the at least one processor is further caused to:
receive a password resetting command entered by the user;
count times for the user to reset the password; and
when the unique and constant website password are automatically generated for the user, the computation items further comprises the password resetting times.
